(19) United States
(12) Patent Application Publication
(10) Pub. No.: US 2023/0137034 A1
(43) Pub. Date: May 4, 2023

(54) METHOD FOR TOKEN-BASED AUTHORIZATION FOR INDIRECT COMMUNICATION BETWEEN NETWORK FUNCTIONS

(71) Applicant: Telefonaktiebolaget LM Ericsson (publ), Stockholm (SE)

(72) Inventor: Christine JOST, Dalby (SE)

(21) Appl. No.: 17/793,592

(22) PCT Filed: Dec. 16, 2020
(86) PCT No.: PCT/SE2020/051220

§ 371 Date: Jul. 18, 2022

Related U.S. Application Data
(60) Provisional application No. 62/964,189, filed on Jan. 22, 2020.

(51) Int. Cl. H04W 12/08; H04W 12/48; H04W 12/71

(52) U.S. Cl. CPC H04W 12/08; H04W 12/48; H04W 12/71

(57) ABSTRACT

A method performed by a first network node having a network repository function. The method comprises: receiving an authorization token request from a service communication proxy, SCP; determining whether or not a network function, NF, service consumer device allows the SCP to represent the NF service consumer device; and responsive to determining that the NF service consumer device allows the SCP to represent the NF service consumer device, transmitting an authorization token to the SCP. A further method, network nodes, computer program and a non-transitory storage medium are also disclosed.

### TECHNICAL FIELD

The disclosure relates to methods performed by a network node having a network repository function, NRF. The disclosure also relates to network nodes, computer program and a non-transitory storage medium.

### BACKGROUND

Service based architecture was introduced in Release 15 of the 3GPP specifications. One of the security mechanisms introduced in Release 15 is token-based authorization, specified also in Release 16 in clause 13.4.1 of TS 33.501 V16.1.0 and clauses 5.4 and 6.3 of TS 29.510 V16.2.0. It is based on the OAuth 2.0 framework as specified in Internet Engineering Task Force (IETF) RFC 6749. The NRF (Network Repository Function, sometimes referred to as NF (Network Function) Repository Function or Network Resource Function) performs the role of an OAuth 2.0 Authorization server in a 3GPP-specified network. An NF (network function) service consumer performs the role of an OAuth 2.0 client and an NF service producer performs the role of an OAuth 2.0 resource server. Before accessing a service at the NF service producer, the NF service consumer needs to obtain an access token from the NRF. The token request may be for a specific NF producer instance or for a type of NF producers. The NRF may grant tokens for access of a type of NF producers, a list of NF instances, or a single NF instance. This information on the type of NF producers, the list of NF instances or the single NF instance is stored in the token audience (see e.g. Table 6.3.5.2.4-1 of TS 29.510 V16.2.0). After the NF service consumer has obtained the token from the NRF, the NF service consumer presents the token to the NF service producer in a service request, and the NF service producer checks whether the token is valid before granting access and/or performing the service.

A procedure that often needs to be performed before service access is service discovery, as described in clause 4.17.4 of TS 23.502 V16.3.0, and clauses 5.3 and 6.2 of TS 29.510 V16.2.0. Service discovery is used to discover producers and services offered by NF service producers in the network. The NF service consumer sends a discovery request to the NRF, and the NRF responds with a set of NF service producer instances. The consumer may send the token request to obtain an access token before the discovery or afterwards. If the NF service consumer has already discovered the NF service producers before sending the token request, the NF service consumer may use the information of available NF service producers when sending the token request.

In Release 16, in addition to the direct communication scenarios of Release15, indirect communication scenarios were introduced. They are described as Scenarios/Communication models C and Din Annex E of TS 23.501 V16.3.0. In Scenario D (indirect communication with delegated discovery), a proxy called SCP (Service Communication Proxy) performs discovery on behalf of the NF service consumer. This is described in clauses 4.17.9 and 4.17.10 of TS 23.502 V16.3.0.

Token-based authorization for indirect communication with delegated discovery is not specified yet, but one possible solution under discussion is that the SCP requests the authorization token on behalf of the NF consumer (Solution #21 in TR 33.855 V1.8.0). The SCP is called SeCoP or SECOP in SA3 documents, i.e. TR 33.855 V1.8.0 and TS 33.501 V16.1.0.

### SUMMARY

An object of the invention is to improve security in a wireless communication network.

A first aspect of the invention relates to a method performed by a first network node having a network repository function. The method comprises: receiving an authorization token request from an SCP; determining whether or not an NF service consumer device allows the SCP to represent the NF service consumer device; and responsive to determining that the NF service consumer device allows the SCP to represent the NF service consumer device, transmitting an authorization token to the SCP. Hereby is enabled that the SCP is permitted to act on behalf of the NF service consumer device only after the first network node has checked that the SCP is allowed to act on behalf of the NF Service consumer device. The first network node/NRF is thus enabled to verify that the authorization token request from the SCP really is on behalf of the NF service consumer device.

The SCP is in an embodiment of the first aspect implemented in a core network node. In an embodiment of the first aspect, the authorization token request identifies an NF service producer device. In this embodiment, the determining whether or not the NF service consumer device allows the SCP to represent the NF service consumer device comprises:

responsive to no consumer identifier being in the authorization token request:
determining which NF service consumer devices are allowed to be represented by the SCP;
determining whether any of the NF service consumer devices that are authorized to invoke services provided by the NF service producer device are authorized to be represented by the SCP; and
responsive to any of the NF service consumer devices that are authorized to invoke services provided by the NF service producer device are authorized to be represented by the SCP,
determining that the NF service consumer device allows the SCP to represent the NF service consumer device;
   responsive to there being the consumer identifier being in the authorization token request:
determining whether the SCP is allowed to represent a NF service consumer device identified by the consumer identifier;
determining whether the NF service consumer device identified by the consumer identifier is authorized to invoke the services provided by the NF service producer device; and
responsive to determining that the SCP is allowed to represent a NF service consumer device identified by the consumer identifier and that the NF service consumer device identified by the consumer identifier is authorized to invoke the services provided by the NF service producer device, determining that the NF service consumer device allows the SCP to represent the NF service consumer device.

The method is in one embodiment, wherein the authorization token request identifies an NF service producer device, comprising:
determining whether or not the NF service producer device identified allows the SCP to represent NF service consumer devices; and
wherein responsive to determining that the NF service consumer device allows the SCP to represent the NF service consumer device, transmitting an authorization token to the SCP comprises responsive to determining that the NF service consumer device allows the SCP to represent the NF service consumer device and determining that the NF service producer device identified allows the SCP to represent NF service consumer devices, transmitting the authorization token to the SCP.

An embodiment of the method comprises: receiving provision information indicating whether or not SCPs are allowed to represent NF service consumer devices; and responsive to the provision information indicating that SCPs are allowed to represent the NF service consumer devices.

A second aspect relates to a method performed by a first network node having a network repository function. The method comprises: receiving an authorization token request from an SCP; determining whether or not an NF service consumer device allows the SCP to represent the NF service consumer device; determining whether or not an NF service producer device identified in the authorization token allows the SCP to represent NF service consumer devices; and responsive to determining that the NF service producer device identified in the authorization token allows the SCP to represent NF service consumer devices and that the NF service consumer device allows the SCP to represent the NF service consumer device, transmitting an authorization token to the SCP.

In an embodiment of the method according to the second aspect, the determining whether or not the NF service consumer device allows the SCP to represent the NF service consumer device comprises:
responsive to no consumer identifier being in the authorization token request:
   determining which NF service consumer devices are allowed to be represented by the SCP;
   determining whether any of the NF service consumer devices that are authorized to invoke services provided by the NF service producer device are authorized to be represented by the SCP; and
   responsive to any of the NF service consumer devices that are authorized to invoke services provided by the NF service producer device are authorized to be represented by the SCP, determining that the NF service consumer device allows the SCP to represent the NF service consumer device; and responsive to there being the consumer identifier being in the authorization token request:
determining whether the SCP is allowed to represent a NF service consumer device identified by the consumer identifier;
   determining whether the NF service consumer device identified by the consumer identifier is authorized to invoke the services provided by the NF service producer device; and
   responsive to determining the SCP is allowed to represent a NF service consumer device identified by the consumer identifier and that the NF service consumer device identified by the consumer identifier is authorized to invoke the services provided by the NF service producer device, determining that the NF service consumer device allows the SCP to represent the NF service consumer device.

An embodiment of the method according to the second aspect comprises receiving provision information indicating whether or not SCPs are allowed to represent NF service consumer devices; and responsive to the provision information indicating that SCPs are allowed to represent the NF service consumer devices, determining which SCPs are allowed to represent the NF service consumer devices. This embodiment and other embodiments disclosed enable the NF service consumer device and the NF service producer device to influence whether SCPs, and which SCPs, are allowed to represent NF service consumer devices. The embodiment allows the first network node to use this provisioning information from a sender when determining whether the first network node/NRF should issue an authorization token for the SCP.

In an embodiment of the first and second aspects, the method may comprise determining whether there is a consumer identifier in the authorization token request.

In an embodiment of the methods according to the first and second aspects, the method comprises: transmitting a provision information acknowledgement message to NF service providers identified in the provision information; receiving a response to the provision information acknowledgement message; responsive to the response indicating an approval to allow SCPs, determining that the NF service producer device allows the SCP to represent the NF service consumer device; and responsive to the response indicating a denial to allow SCPs, determining that the NF service producer device does not allow the SCP to represent the NF service consumer device.

In an embodiment of the methods according to the first and second aspects, the method comprises: transmitting a provision information acknowledgement message to NF service consumer devices identified in the provision information; receiving a response to the provision information acknowledgement message; responsive to the response indicating an approval to allow SCPs, determining that the NF service consumer device allows the SCP to represent the NF service consumer device; and responsive to the response indicating a denial to allow SCPs, determining that the NF service consumer device does not allow the SCP to represent the NF service consumer device.

In an embodiment according to the first and second aspects, the method comprises transmitting a provision information acknowledgement message to a sender of the provision information.

In an embodiment of the first and second aspects, the method comprises: receiving a response to the provision information acknowledgement message transmitted to the sender; responsive to the response indicating an approval to allow SCPs, determining that the SCP is allowed to represent the NF service consumer device; and responsive to the response indicating a denial to allow SCPs, determining that the SCP is not allowed to represent the NF service consumer device.

A third aspect relates to a first network node which comprises a network repository function, processing circuitry, and memory coupled with the processing circuitry, wherein the memory includes instructions that when executed by the processing circuitry causes the first network node to perform operations comprising:

receiving an authorization token request from an SCP;
determining whether or not an NF service consumer device allows the SCP to represent the NF service consumer device; and
responsive to determining that the NF service consumer device allows the SCP to represent the NF service consumer device, transmitting an authorization token to the SCP.

The memory includes instructions that when executed by the processing circuitry causes the first network node to perform operations according to any one of the described embodiments of the method according to the first and second aspects.

A fourth aspect relates to a computer program comprising program code to be executed by a processing circuitry of a first network node having a network repository function, whereby execution of the program code causes the first network node to perform operations comprising: receiving an authorization token request from an SCP; determining whether or not an NF service consumer device allows the SCP to represent the NF service consumer device; and responsive to determining that the NF service consumer device allows the SCP to represent the NF service consumer device, transmitting an authorization token to the SCP.

A fifth aspect relates to a non-transitory storage medium including program code to be executed by processing circuitry of a first network node comprising a network function repository, whereby execution of the program code causes the first network node to perform operations comprising: receiving an authorization token request from an SCP; determining whether or not an NF service consumer device allows the SCP to represent the NF service consumer device; and responsive to determining that the NF service consumer device allows the SCP to represent the NF service consumer device, transmitting an authorization token to the SCP.

A sixth aspect relates to a first network node having a network repository function adapted to perform operations comprising: receiving an authorization token request from an SCP; determining whether or not an NF service consumer device allows the SCP to represent the NF service consumer device; and responsive to determining that the NF service consumer device allows the SCP to represent the NF service consumer device, transmitting an authorization token to the SCP.

In an embodiment of the first network node, wherein the authorization token request identifies an NF service producer device and in determining whether or not the NF service consumer device allows the SCP to represent the NF service consumer device, the first network node is adapted to perform operations comprising:

responsive to no consumer identifier being in the authorization token request:
determining which NF service consumer devices are allowed to be represented by the SCP;
determining whether any of the NF service consumer devices that are authorized to invoke services provided by the NF service producer device are authorized to be represented by the SCP; and
responsive to any of the NF service consumer devices that are authorized to invoke services provided by the NF service producer device are authorized to be represented by the SCP, determining that the NF service consumer device allows the SCP to represent the NF service consumer device; and
   responsive to there being the consumer identifier in the authorization token request:
determining whether the SCP is allowed to represent a NF service consumer device identified by the consumer identifier;
determining whether the NF service consumer device identified by the consumer identifier is authorized to invoke the services provided by the NF service producer device; and
responsive to determining the SCP is allowed to represent a NF service consumer device identified by the consumer identifier and that the NF service consumer device identified by the consumer identifier is authorized to invoke the services provided by the NF service producer device, determining that the NF service consumer device allows the SCP to represent the NF service consumer device.

In an embodiment of the first network node, wherein the authorization token request identifies an NF service producer device, the first network node is adapted to perform operations comprising: determining whether or not the NF service producer device identified allows the SCP to represent NF service consumer devices and wherein responsive to determining that the NF service consumer device allows the SCP to represent the NF service consumer device, transmitting an authorization token to the SCP comprises responsive to determining that the NF service consumer device allows the SCP to represent the NF service consumer device and determining that the NF service producer device identified allows the SCP to represent NF service consumer devices, transmitting the authorization token to the SCP.

A seventh aspect relates to a first network node having a network repository function. The first network node is adapted to perform operations comprising: receiving an authorization token request from an SCP; determining whether or not a Network Function, NF, service consumer device allows the SCP to represent the NF service consumer device; determining whether or not an NF service producer device identified in the authorization token allows the SCP to represent NF service consumer devices; and responsive to determining that the NF service producer device identified in the authorization token allows the SCP to represent NF service consumer devices and that the NF service consumer device allows the SCP to represent the NF service consumer device, transmitting an authorization token to the SCP.

The first network node of the seventh aspect is in one embodiment, wherein in determining whether or not the NF service consumer device allows the SCP to represent the NF service consumer device, adapted to perform further operations comprising:

responsive to no consumer identifier being in the authorization token request:
determining which NF service consumer devices are allowed to be represented by the SCP;
determining whether any of the NF service consumer devices that are authorized to invoke services provided by the NF service producer device are authorized to be represented by the SCP; and
responsive to any of the NF service consumer devices that are authorized to invoke services provided by the NF service producer device are authorized to be represented by the SCP, determining that the NF service consumer device allows the SCP to represent the NF service consumer device;
   responsive to there being the consumer identifier being in the authorization token request:
determining whether the SCP is allowed to represent an NF service consumer device identified by the consumer identifier;
determining whether the NF service consumer device identified by the consumer identifier is authorized to invoke the services provided by the NF service producer device; and
responsive to determining the SCP is allowed to represent a NF service consumer device identified by the consumer identifier and that the NF service consumer device identified by the consumer identifier is authorized to invoke the services provided by the NF service producer device, determining that the NF service consumer device allows the SCP to represent the NF service consumer device.

The first network node according to the sixth and seventh aspects is in an embodiment adapted to perform operations comprising: determining whether there is a consumer identifier in the authorization token request.

The first network node according to the sixth and seventh aspect is in one embodiment adapted to perform operations comprising: receiving provision information indicating whether or not SCPs are allowed to represent NF service consumer devices; and responsive to the provision information indicating that SCPs are allowed to represent the NF service consumer devices, determining which SCPs are allowed to represent the NF service consumer devices.

The first network node is in one embodiment according to the sixth and seventh aspects adapted to perform operations comprising:

transmitting a provision information acknowledgement message to NF service consumer devices identified in the provision information;
receiving a response to the provision information acknowledgement message;
responsive to the response indicating an approval to allow SCPs, determining that the NF service consumer device allows the SCP to represent the NF service consumer device; and
responsive to the response indicating a denial to allow SCPs, determining that the NF service consumer device does not allow the SCP to represent the NF service consumer device.

The first network node is in one embodiment according to the sixth and seventh aspects adapted to perform operations comprising:

transmitting a provision information acknowledgement message to NF service providers identified in the provision information;
receiving a response to the provision information acknowledgement message;
responsive to the response indicating an approval to allow SCPs, determining that the NF service producer device allows the SCP to represent the NF service consumer device; and
responsive to the response indicating a denial to allow SCPs, determining that the NF service producer device does not allow the SCP to represent the NF service consumer device.

The first network node is in an embodiment of the sixth and seventh aspects adapted to perform operations comprising: transmitting a provision information acknowledgement message to a sender of the provision information.

The first network node is in an embodiment of the sixth and seventh aspects adapted to perform operations comprising: receiving a response to the provision information acknowledgement message transmitted to the sender; responsive to the response indicating an approval to allow SCPs, determining that the SCP is allowed to represent the NF service consumer device; and responsive to the response indicating a denial to allow SCPs, determining that the SCP is not allowed to represent the NF service consumer device.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is signaling diagram illustrating communications between a first network node/function and an NF consumer device according to some embodiments of inventive concepts;

FIG. 2 is a signaling diagram illustrating communications between an SCP node and an NRF node according to some embodiments of inventive concepts;

FIG. 3 is a block diagram illustrating a NF consumer device according to some embodiments of inventive concepts;

FIG. 4 a block diagram illustrating an SCP node according to some embodiments of inventive concepts;

FIG. 5 is a block diagram illustrating an NRF node according to some embodiments of inventive concepts;

FIGS. 6-10 are flow charts illustrating operations of a first network node according to some embodiments of inventive concepts;

FIG. 11 is a block diagram of a wireless network in accordance with some embodiments; and

FIG. 12 is a block diagram of a virtualization environment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

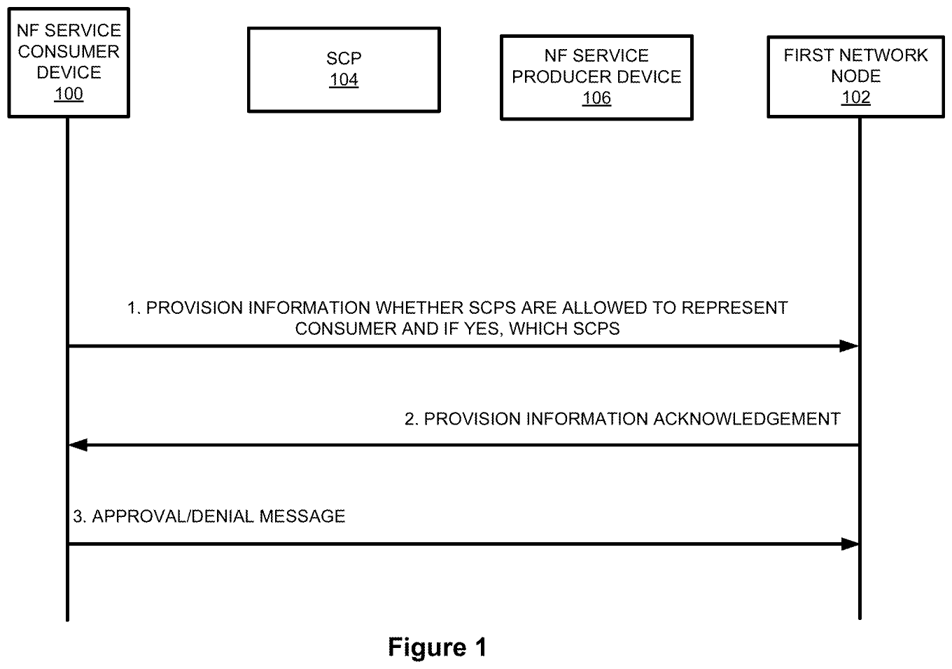

FIG. 1 is a signaling diagram illustrating signals transmitted to and from a Network Function, NF, service consumer device 100 and a first network node 102 which implements a Network Repository Function, NRF, (and thus can also be referred to as the first network function or just ‘NRF’) The NF service consumer device 100 is in other words a device which is on the consuming end of a network function service provided by an NF in a wireless communication network, such as a 5G network or any future corresponding network, like a future 6G network. The NF service consumer device is in an embodiment a core network node, such as a 5G Core network node provided with a network function. The first network node 102 is an apparatus which runs the NRF in the wireless communication network, in which the apparatus may be positioned in a core network of the wireless communication network, such as in a 5G core network or any future network, such as a core network for a 6G network or a mesh network of a possible 6G network. Operations mentioned as being performed by the first network node 102 below are to be seen as operations enabled by the NRF, i.e. it can equally be said that the NRF performs the operations/actions/steps described below whenever the first network node performs the operations.

In operation 1 illustrated with the arrow 1 in FIG. 1, the first network node 102, in a configuration step, receives provision information indicating whether one or more second network nodes, e.g. Service Communication Proxies, SCPs 104 are allowed to represent an NF service consumer associated with the NF service consumer device 100, or in other words represent the NF service consumer device 100, and if yes (i.e. SCPs are allowed to represent the NF service consumers) which SCPs 104. The term SCP is here also attributed to a computer running SCP software, e.g. being an SCP server or an SCP node. The SCP 104 may in an embodiment be comprised in a separate device/node/server, but may in other embodiments be at least partly comprised in a core network device also hosting one or more network functions. The SCP may for example be at least partly comprised, e.g. in the form of an SCP agent, in the NF service consumer device 100. The provision information is received from one of the NF service consumer device 100, an NRF service producer, an O&M system, or an enrollment agent. Thus, provision information could be sent by the NF service consumer device or an NF service producer device 106 itself, e.g. in their profile. It could also be sent in the O&M system. Thirdly, it could also be an enrollment agent that enrolls new network functions in the network.

In operation 2 illustrated with arrow 2, the first network node 102 in some embodiments may send a provision information acknowledgment message to the sender of the provision information and/or to the NF service consumer device and/or to the NF service producer device. The provision information acknowledgment message in some of these embodiments requests that the NF service consumer device and/or the NF service producer device approves the allowance of the SCP representing the NF service consumer device. In these embodiments, responsive to receiving the provision information acknowledgment message, the NF service consumer device and/or NF service producer device in operation 3, illustrated by arrow 3, transmits an approval message or a denial message to the first network node 102. The first network node 102 determines whether or not the NF service producer device allows and whether or not the NF service consumer device allows an SCP 104 to represent the NF service consumer device.

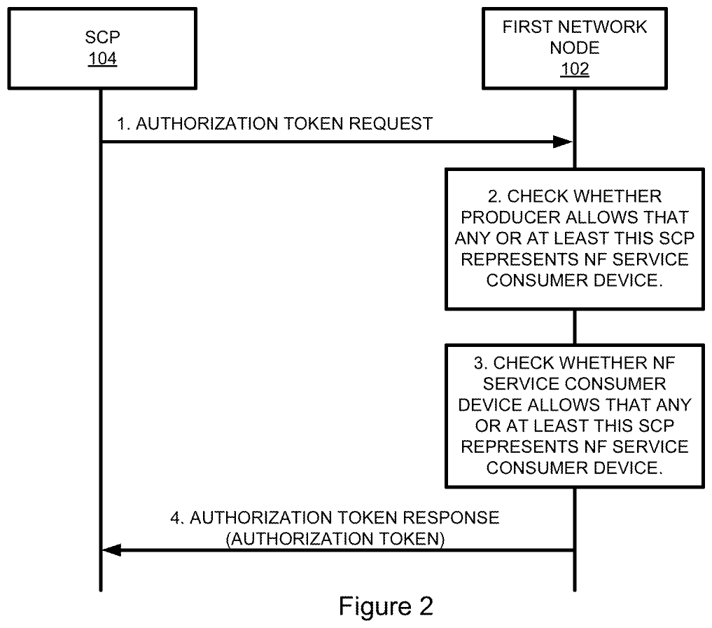

Turning to FIG. 2, in some embodiments, the second network node, here in the form of the SCP 104 may transmit one or more authorization token requests to the first network node 102 on behalf of NF service consumer devices. In operation 1 of FIG. 2, the first network node 102 receives an authorization token request from an SCP 104. The authorization token request may or may not include an identifier of the NF service consumer device the SCP 104 represents. The transmission of the authorization token request may be made with a Hypertext Transfer Protocol message, in which case the SCP is or comprises an HTTP proxy.

In operation 2 of FIG. 2, the first network node 102 checks whether or not the desired NF service producer device allows that any SPC 104, or at least this SCP 104, represents NF service consumer devices.

In operation 3 of FIG. 2, the first network node 102, if there was no NF service consumer device identifier sent in operation 1, checks which NF service consumer devices are allowed to be represented by this SCP 104. The NRF of the first network node 102 then checks whether any of the NF service consumer devices that are authorized to invoke the NF service producer devices' services also is authorized to be represented by this or any SCP 104. If an NF service consumer device identifier was sent in step 1, the NRF checks whether the SCP 104 is allowed to represent this NF service consumer device, and whether the NF service consumer device is authorized to invoke the NF service producer device's services.

Operations 2 and 3 may occur in any order. Operation 3 may in other words happen before Operation 2.

In operation 4, if the checks in step 2 and 3 were successful, the first network node 102 transmits an authorization token back to the SCP 104. The authorization token may be issued for the SCP 104, the NF service consumer device, or the SCP 104 on behalf of the NF service consumer device. The transmission of the authorization token response may be made with a Hypertext Transfer Protocol message.

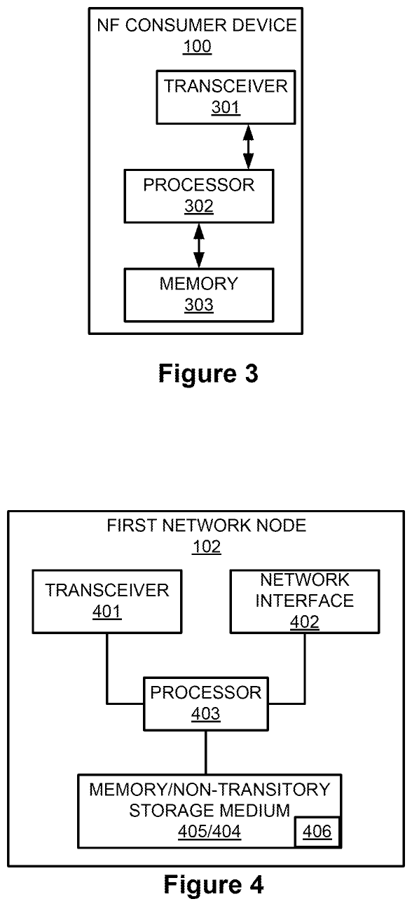

FIG. 3 is a block diagram illustrating elements of an embodiment of an NF service consumer device 100 configured to provide wireless communication according to embodiments. As shown, NF service consumer device 100 may include a transceiver circuitry 301 (also referred to as a transceiver) including a transmitter and a receiver configured to provide communications with an SCP(s). The NF service consumer device 100 also includes a processing circuitry 302 (also referred to as a processor) coupled to the transceiver circuitry, and memory circuitry 303 (also referred to as memory) coupled to the processing circuitry. The memory circuitry 303 may include computer readable program code that when executed by the processing circuitry 323 causes the processing circuitry to perform operations according to embodiments disclosed herein. According to other embodiments, processing circuitry 302 may be defined to include memory so that separate memory circuitry is not required. NF service consumer device 100 may also include an interface (such as a user interface) coupled with processing circuitry 302.

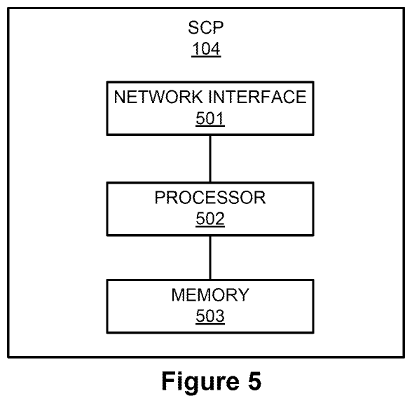

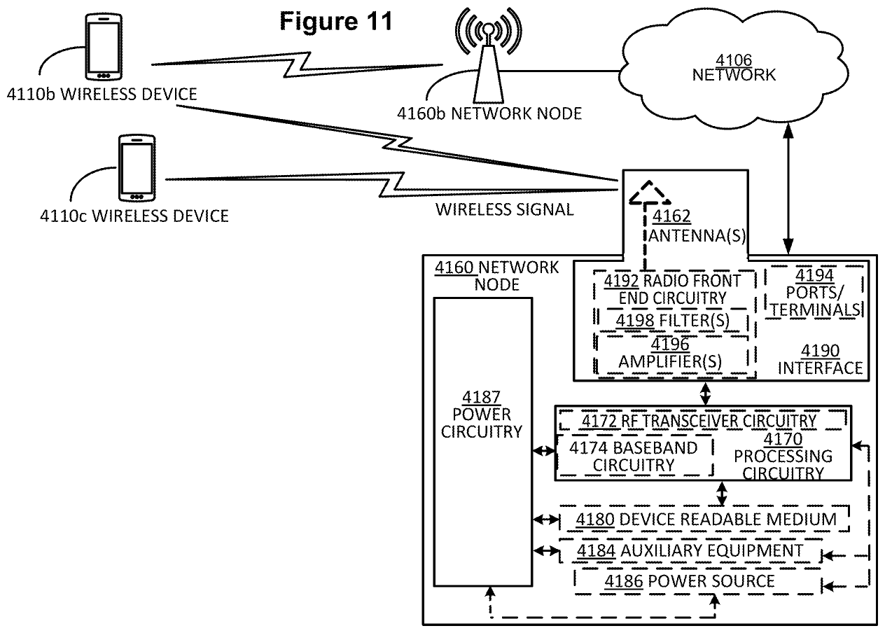

As discussed herein, operations of NF service consumer device 100 may be performed by processing circuitry 302 and/or transceiver circuitry 301. For example, processing circuitry 302 may control transceiver circuitry 301 to transmit communications through transceiver circuitry 301 over a radio interface to a radio access network node (also referred to as a base station) and/or to receive communications through transceiver circuitry 301 from a RAN node such as over a radio interface. Moreover, modules may be stored in memory circuitry 303, and these modules may provide instructions so that when instructions of a module are executed by processing circuitry 302, processing circuitry 302 performs respective operations (e.g., operations discussed below with respect to Example Embodiments relating to NF service consumer devices). The NF service consumer device may for example be a network device which comprises and acts as anyone of Access and Mobility Management Function (AMF), Session Management Functions (SMF), Authentication Server Functions (AUSF), Security Anchor Functions (SEAF), Authentication credential Repository and Processing Function (ARPF), Unified Data Management (UDM), and Subscription Identifier De-concealing Function, (SIDF). FIG. 4 is a block diagram illustrating elements of the first network node 102. As shown, the first network node 02 may include transceiver circuitry 401 (also referred to as a transceiver, e.g., corresponding to portions of interface 4190 of FIG. 11) including a transmitter and a receiver configured to provide uplink and downlink radio communications with mobile terminals. The first network node may include network interface circuitry 402 (also referred to as a network interface, e.g., corresponding to portions of interface 4190 of FIG. 11) configured to provide communications with other nodes (e.g., with other SCP nodes) of the RAN and/or core network CN. The first network node 102 also includes a processing circuitry 403 (also referred to as a processor, e.g., corresponding to processing circuitry 4170) coupled to the transceiver circuitry, and a non-transitory storage medium 404 memory circuitry 405 (also referred to as memory, e.g., corresponding to device readable medium 4180 of FIG. 11) coupled to the processing circuitry. The memory circuitry 405 may include a computer program 406 with computer readable program code that when executed by the processing circuitry 403 causes the processing circuitry to perform operations according to embodiments disclosed herein. According to other embodiments, processing circuitry 403 may be defined to include memory so that a separate memory circuitry is not required.

As discussed herein, operations of the first network node 102 may be performed by processing circuitry 403, network interface 402, and/or transceiver 401. For example, processing circuitry 403 may control transceiver 401 to transmit downlink communications through transceiver 401 over a radio interface to one or more NF consumer devices and other terminals and/or to receive uplink communications through transceiver 401 from one or more NF consumer devices over a radio interface. Similarly, processing circuitry 403 may control network interface 402 to transmit communications through network interface 402 to one or more other network nodes and/or to receive communications through network interface from one or more other network nodes. Moreover, modules may be stored in memory 405, and these modules may provide instructions so that when instructions of a module are executed by processing circuitry 403, processing circuitry 403 performs respective operations (e.g., operations discussed below with respect to Example Embodiments relating to the first network node).

According to some other embodiments, the first network node may be implemented as a core network CN node without the transceiver.

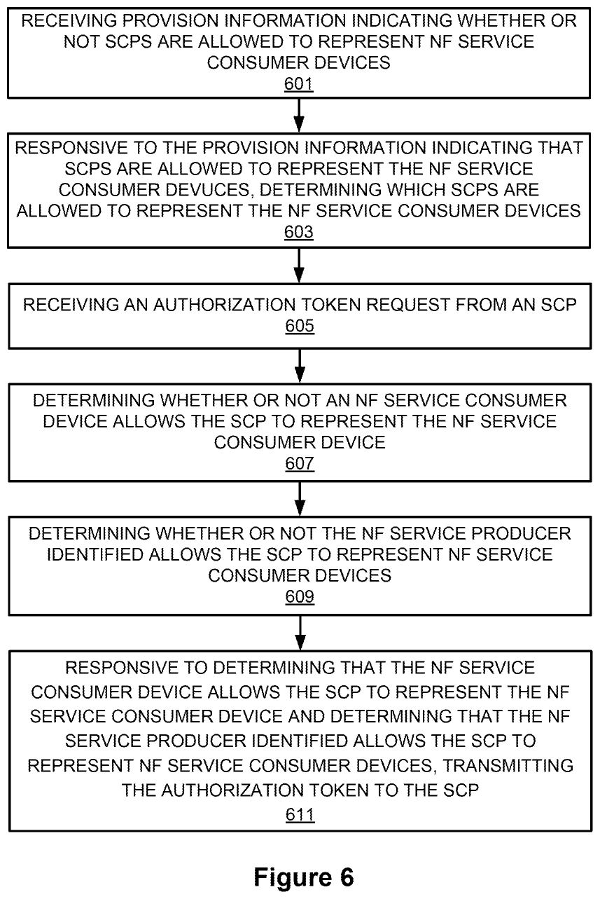

FIG. 5 is a block diagram illustrating elements of the SCP 104 of a communication network configured to provide cellular communication according to embodiments. As shown, the SCP 104 may include network interface circuitry 501 (also referred to as a network interface) configured to provide communications with other nodes of the core network and/or the radio access network RAN. The SCP 104 also includes a processing circuitry 502 (also referred to as a processor) coupled to the network interface circuitry, and memory circuitry 503 (also referred to as memory) coupled to the processing circuitry. The memory circuitry 503 may include computer readable program code that when executed by the processing circuitry 502 causes the processing circuitry to perform operations according to embodiments disclosed herein. According to other embodiments, processing circuitry 502 may be defined to include memory so that a separate memory circuitry is not required.

As discussed herein, operations of the SCP 104 may be performed by processing circuitry 502 and/or the network interface 501. Processing circuitry 502 may control network interface 501 to transmit communications through network interface 501 to one or more other network nodes and/or to receive communications through network interface from one or more other network nodes. Moreover, modules may be stored in memory 503, and these modules may provide instructions so that when instructions of a module are executed by processing circuitry 502, processing circuitry 502 performs respective operations (e.g., operations discussed below with respect to Example Embodiments relating to second network node/functions).

As indicated above, the first network node 102 and the SCP 104 may have the following problem: There is no direct authentication between the NF service consumer device and the first network node 102 when the SCP 104 is allowed to request authentication tokens on behalf of the NF service consumer device 100. Hence, the first network node 102 has no way of verifying that the authorization token request is on behalf of the NF service consumer device or whether the SCP node is authorized to request authorization tokens on behalf of the NF service consumer device.

In some embodiments, the consumer and/or producer register information at the first network node 102 that indicates whether SCPs are allowed to represent consumers, and if yes, which SCPs. The first network node 102 uses this information when determining whether it should issue an authorization token for the SCP 104 when an authorization request is received by the first network node 102. One advantage that may be achieved by these embodiments is that the NF service consumer device and NF service producer devices can influence whether SCPs are allowed to represent NF service consumer devices, and if allowed, determine which SCPs are to be allowed to represent the NF service consumer devices.

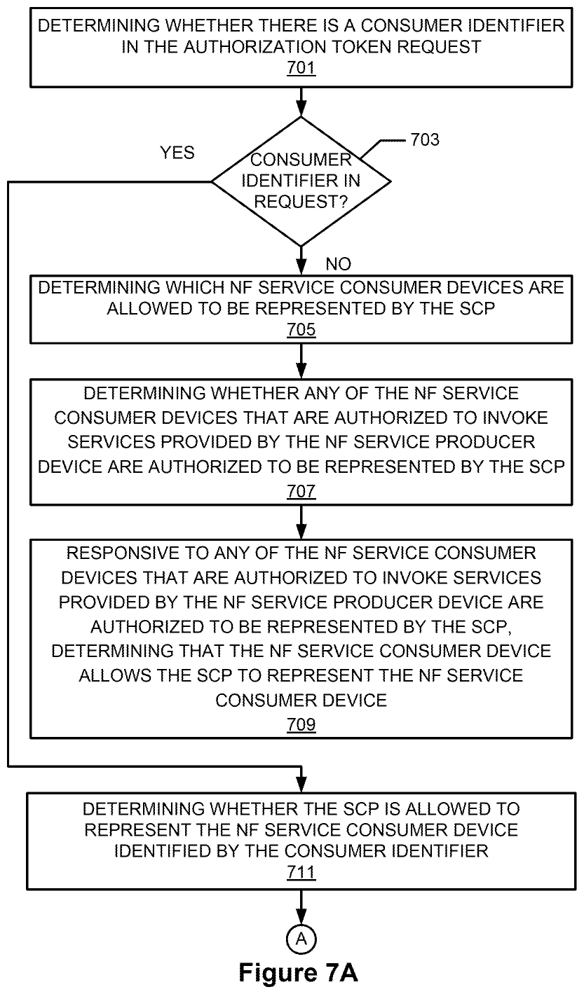

Operations of the first network node 102 (implemented using the structure of the block diagram of FIG. 4) will now be discussed with reference to the flow chart of FIG. 6 according to some embodiments. For example, modules may be stored in memory 503 of FIG. 4, and these modules may provide instructions so that when the instructions of a module are executed by respective wireless device processing circuitry 502, processing circuitry 502 performs respective operations of the flow chart.

Turning now to FIG. 6, in block 601, the processing circuitry 403, via network interface circuitry 402 or transceiver circuitry 401, may receive provision information indicating whether or not SCPs are allowed to represent NF service consumers/NF service consumer devices. The provision information may also include a listing of the SCPs that are allowed to represent NF service consumers devices. The first network node 102 is a network repository function, NRF, node/function. In other words, the first network node 102 implements an NRF.

In block 603, the processing circuitry 403 may, responsive to the provision information indicating that SCPs 104 are allowed to represent the NF service consumer devices determine which SCPs 104 are allowed to represent the NF service consumer devices.

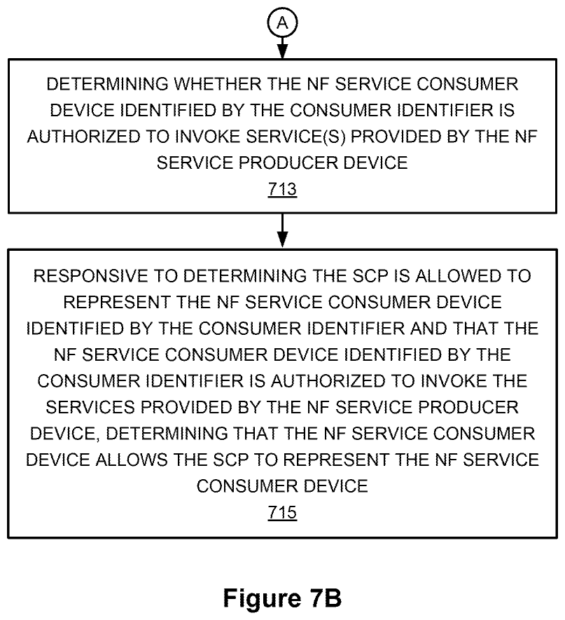

In block 605, the processing circuitry 403 may receive an authorization token request from the SCP 104. The authorization token request in some embodiments includes a consumer identifier. In block 607, the processing circuitry 403 may determine whether or not an NF service consumer device allows the SCP to represent the NF service consumer device. The authorization token request may also include an identification of an NF service producer device. Turning now to FIGS. 7A and 7B, in block 701, processing circuitry 403 determines whether there is a consumer identifier in the authorization token request. If there is no consumer identifier in the request, the processing circuitry 403 may determine, in block 705, which NF service consumer devices are allowed to be represented by the SCP. In block 707, the processing circuitry 403 may determine whether any of the NF service consumer devices that are authorized to invoke services provided by the NF service producer devices are authorized to be represented by the SCP. In block 709, responsive to any of the NF service consumer devices that are authorized to invoke services provided by the NF service producer device are authorized to be represented by the SCP, the processing circuitry 403 may determine that the NF service consumer device allows the SCP to represent the NF service consumer device.

If there is a consumer identifier in the authorization token request, the processing circuitry 403 may determine in block 711 whether the SCP is allowed to represent an NF service consumer device identified by the consumer identifier. In block 713, the processing circuitry 403 may determine whether the NF service consumer device identified by the consumer identifier is authorized to invoke the services provided by the NF service producer device.

In block 715, responsive to determining the SCP is allowed to representing the NF service consumer device identified by the consumer identifier and that the NF service consumer device identified by the consumer identifier is authorized to invoke the services provided by the NF service producer device, the processing circuitry 403 may determine that the NF service consumer device allows the SCP to represent the NF service consumer device.

In some embodiments, there is always a consumer identifier in the authorization token request. In these embodiments, the processing circuitry 403 performs blocks 711, 713, and 715 and does not need to perform blocks 701, 705, 707, and 709. In other embodiments, there is no consumer identifier in the authorization token. In these other embodiments, the processing circuitry 403 performs blocks 705, 707, and 709 and does not need to perform blocks 701, 711, 713, and 715.

Returning to FIG. 6, in block 609, processing circuitry 403 may determine whether or not the NF service producer device identified allows the SCP to represent NF service consumer devices. In block 611, the processing circuitry 403 may, responsive to determining that the NF service consumer device allows the SCP to represent the NF service consumer device, transmit an authorization token to the SCP. In embodiments where the first network node determines whether or not the NF service producer device identified allows the SCP to represent NF service consumer devices, the first network node transmits the authorization token to the SCP responsive to determining that the NF service consumer device allows the SCP to represent the NF service consumer device and that the NF service producer device identified allows the SCP to represent NF service consumer devices.

Various operations from the flow chart of FIG. 6 may be optional with respect to some embodiments of first network node and related methods. Regarding methods of example embodiment 1 (set forth below), for example, operations of blocks 601, 602, and 609 of FIG. 6 may be optional.

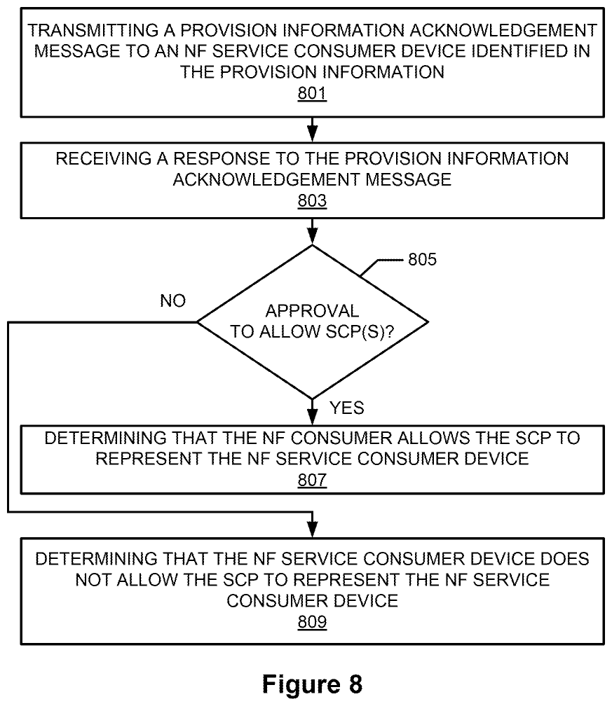

In some embodiments, the first network node 102 may transmit a provision information acknowledgment message to NF service consumer devices identified in the provision information received. The allows the NF service consumer devices to allow or deny a second network node/function, here an SCP to act on the behalf of the NF service consumer devices. Turning to FIG. 8, processing circuitry 403 may transmit a provision information acknowledgment message to NF service consumer devices identified in the provision information in block 801. In block 803, the processing circuitry 403 may receive a response to the provision information acknowledgment message. In block 805, processing circuitry 403 determines whether the response indicates an approval or a denial to allow SCPs to represent the NF service consumer device. In block 807, responsive to the response indicating an approval to allow SCPs, the processing circuitry 403 may determine that the NF service consumer device allows the SCP to represent the NF service consumer device. In block 809, the processing circuitry may, responsive to the response indicating a denial to allow SCP, determine that the NF service consumer device does not allow the SCP to represent the NF service consumer device.

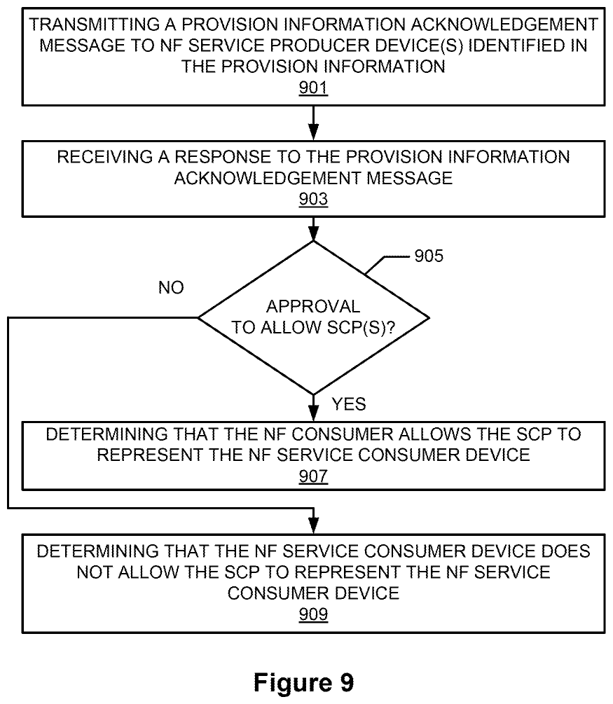

In other embodiments, the first network node 102 may transmit a provision information acknowledgment message to NF service producer devices identified in the provision information received. Turning to FIG. 9, processing circuitry 403 may transmit a provision information acknowledgment message to NF service producer devices identified in the provision information in block 901. In block 903, the processing circuitry 403 may receive a response to the provision information acknowledgment message. In block 905, processing circuitry 403 determines whether the response indicates an approval or a denial to allow SCPs to represent the NF service consumer device. In block 907, responsive to the response indicating an approval to allow SCPs, the processing circuitry 403 may determine that the NF service producer device allows the SCP to represent the NF service consumer device. In block 909, the processing circuitry may, responsive to the response indicating a denial to allow SCPs, determine that the NF service producer device does not allow the SCP to represent the NF service consumer device.

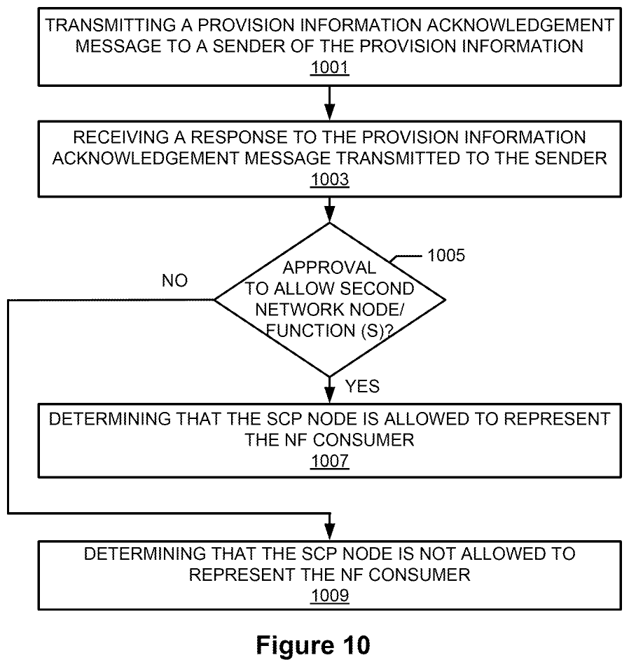

In some embodiments, the NF service consumer device or the NF service producer device may not have a direct secure channel to the first network node. In such cases, an O& M system or an enrollment agent may act on behalf of the NF service consumer device or the NF service producer device and send the provision information to the first network node. Turning to FIG. 10, in these embodiments, the receiving circuitry 403 may transmit a provision information acknowledgment message to a sender of the provision information in block 1001. In block 1003, the processing circuitry 403 may receive a response to the provision information acknowledgment message that was transmitted to the sender.

In block 1005, processing circuitry 403 may determine whether the response indicates an approval or denial to allow SCPs to represent the NF service consumer device. Responsive to the response indicating an approval to allow SCPs, the processing circuitry 403 may determine that the SCP is allowed to represent the NF service consumer device. In block 1009, the processing circuitry may, responsive to the response indicating a denial to allow SCPs, determine that the SCP is not allowed to represent the NF service consumer device.

Example embodiments within this disclosure are discussed below.

1. A method performed by a first network node/function, the method comprising:

receiving, 605, an authorization token request from a second network node;

determining, 607, whether or not a network function, NF consumer allows the second network node/function to represent the NF consumer; and

responsive to determining that the NF consumer allows the second network node to represent the NF consumer, transmitting, 611, an authorization token to the second network node.

2. The method of Embodiment 1 wherein the first network node implements a Network Repository Function, NRF and the second network node implements a service communication proxy, SCP.
3. The method of any of Embodiments 1-2, wherein the authorization token request identifies an NF service producer and wherein determining whether or not the NF consumer allows the second network node to represent the NF consumer comprises:

responsive, 703, to no consumer identifier being in the authorization token request:
determining, 705, which NF consumers are allowed to be represented by the second network node;
determining, 707, whether any of the NF consumers that are authorized to invoke services provided by the NF service producer are authorized to be represented by the second network node; and
responsive to any of the NF consumers that are authorized to invoke services provided by the NF service producer are authorized to be represented by the second network node, determining, 709, that the NF consumer allows the second network node to represent the NF consumer;
   responsive, 703, to there being the consumer identifier being in the authorization token:
determining, 711, whether the second network node is allowed to represent a NF consumer identified by the consumer identifier;
determining, 713, whether the NF consumer identified by the consumer identifier is authorized to invoke the services provided by the NF service producer; and
responsive to determining the second network node is allowed to represent a NF consumer identified by the consumer identifier and that the NF consumer identified by the consumer identifier is authorized to invoke the services provided by the NF service producer, determining, 715, that the NF consumer allows the second network node to represent the NF consumer.
   4. The method of Embodiment 3, further comprising:

determining, 701, whether there is a consumer identifier in the authorization token request;

5. The method of any of Embodiments 1-4, wherein the authorization token request identifies an NF service producer, the method further comprising:

determining, 609, whether or not the NF service producer identified allows the second network node to represent NF consumers; and

wherein responsive to determining that the NF consumer allows the second network node to represent the NF consumer, transmitting, 611, an authorization token to the second network node comprises responsive to determining that the NF consumer allows the second network node to represent the NF consumer and determining that the NF service producer identified allows the second network node to represent NF consumers, transmitting the authorization token to the second network node.

6. The method of any of Embodiments 1-5, further comprising:

receiving, 601, provision information indicating whether or not second network nodes are allowed to represent NF consumers; and

responsive to the provision information indicating that second network nodes are allowed to represent the NF consumers, determining, 603, which second network nodes are allowed to represent the NF consumers.

7. The method of Embodiment 6, further comprising:

transmitting, 801, a provision information acknowledgement message to NF consumers identified in the provision information;

receiving, 803, a response to the provision information acknowledgement message;

responsive, 805, to the response indicating an approval to allow second network nodes, determining, 807, that the NF consumer allows the second network node to represent the NF consumer; and

responsive, 805, to the response indicating a denial to allow second network nodes, determining, 809, that the NF consumer does not allow the second network node to represent the NF consumer.

8. The method of any of Embodiments 6-7, further comprising:

transmitting, 901, a provision information acknowledgement message to NF service providers identified in the provision information;

receiving, 903, a response to the provision information acknowledgement message;

responsive, 905, to the response indicating an approval to allow second network nodes, determining, 907, that the NF service producer allows the second network node to represent the NF consumer; and

responsive, 905, to the response indicating a denial to allow second network nodes, determining, 909, that the NF service producer does not allow the second network node to represent the NF consumer.

9. The method of any of Embodiments 6-8, further comprising:

transmitting, 1001, a provision information acknowledgement message to a sender of the provision information.

10. The method of Embodiment 9, further comprising:

receiving, 1003, a response to the provision information acknowledgement message transmitted to the sender;

responsive, 1005, to the response indicating an approval to allow second network nodes, determining, 1007, that the second network node is allowed to represent the NF consumer; and

responsive, 1005, to the response indicating a denial to allow second network nodes, determining, 1009, that the second network node is not allowed to represent the NF consumer.

11. A method performed by a first network node 102, the method comprising:

receiving, 605, an authorization token request from a second network node;

determining, 607, whether or not a Network Function, NF, consumer allows the second network node to represent the NF consumer;

determining, 609, whether or not an NF service producer identified in the authorization token allows the second network node to represent NF consumers; and

responsive to determining that the NF service producer identified in the authorization token allows the second network node to represent NF consumers and that the NF consumer allows the second network node to represent the NF consumer, transmitting, 611, an authorization token to the second network node.

12. The method of Embodiment 10 wherein the first network node implements a Network Repository Function, NRF and the second network node implements a service communication proxy, SCP.
13. The method of any of Embodiments 11-12, wherein determining whether or not the NF consumer allows the second network node to represent the NF consumer comprises:

responsive, 703, to no consumer identifier being in the authorization token request:
determining, 705, which NF consumers are allowed to be represented by the second network node;
determining, 707, whether any of the NF consumers that are authorized to invoke services provided by the NF service producer are authorized to be represented by the second network node; and
responsive to any of the NF consumers that are authorized to invoke services provided by the NF service producer are authorized to be represented by the second network node, determining, 709, that the NF consumer allows the second network node to represent the NF consumer;

responsive, 703, to there being the consumer identifier being in the authorization token:
determining, 711, whether the second network node is allowed to represent a NF consumer identified by the consumer identifier;
determining, 713, whether the NF consumer identified by the consumer identifier is authorized to invoke the services provided by the NF service producer; and
responsive to determining the second network node is allowed to represent a NF consumer identified by the consumer identifier and that the NF consumer identified by the consumer identifier is authorized to invoke the services provided by the NF service producer, determining, 715, that the NF consumer allows the second network node to represent the NF consumer.
   14. The method of Embodiment 13, further comprising:
determining, 701, whether there is a consumer identifier in the authorization token request.
   15. The method of any of Embodiments 13-14, further comprising:

receiving, 601, provision information indicating whether or not second network nodes are allowed to represent NF consumers; and

responsive to the provision information indicating that second network nodes are allowed to represent the NF consumers, determining, 603, which second network nodes are allowed to represent the NF consumers.

16. The method of Embodiment 15, further comprising:

transmitting, 801, a provision information acknowledgement message to NF consumers identified in the provision information;

receiving, 803, a response to the provision information acknowledgement message;

responsive, 805, to the response indicating an approval to allow second network nodes, determining, 807, that the NF consumer allows the second network node to represent the NF consumer; and

responsive, 805, to the response indicating a denial to allow second network nodes, determining, 809, that the NF consumer does not allow the second network node to represent the NF consumer.

17. The method of any of Embodiments 15-16, further comprising:

transmitting, 901, a provision information acknowledgement message to NF service providers identified in the provision information;

receiving, 903, a response to the provision information acknowledgement message;

responsive, 905, to the response indicating an approval to allow second network nodes, determining, 907, that the NF service producer allows the second network node to represent the NF consumer; and

responsive, 905, to the response indicating a denial to allow second network nodes, determining, 909, that the NF service producer does not allow the second network node to represent the NF consumer.

18. The method of any of Embodiments 15-17, further comprising:

transmitting, 1001, a provision information acknowledgement message to a sender of the provision information.

19. The method of Embodiment 18, further comprising:

receiving, 1003, a response to the provision information acknowledgement message transmitted to the sender;

responsive, 1005, to the response indicating an approval to allow second network nodes, determining, 1007, that the second network node is allowed to represent the NF consumer; and

responsive, 1005, to the response indicating a denial to allow second network nodes, determining, 1009. that the second network node is not allowed to represent the NF consumer.

20. A first network node 102 comprising:

processing circuitry 403; and

memory 405 coupled with the processing circuitry, wherein the memory includes instructions that when executed by the processing circuitry causes the service communication proxy to perform operations comprising:
receiving, 605, an authorization token request from a second network node;
determining, 607, whether or not a network function, NF consumer allows the second network node to represent the NF consumer; and
responsive to determining that the NF consumer allows the second network node to represent the NF consumer, transmitting, 611, an authorization token to the second network node.
   21. The first network node function according to Embodiment 20 wherein the first network node comprises a network resource function, NRF, node and the second network node comprises a service communication proxy, SCP, node.
   22. The first network node 102 according to any of Embodiments 20-21 wherein the memory includes instructions that when executed by the processing circuitry causes the service communication proxy to perform operations according to any of Embodiments 2-19.
   23. A computer program comprising program code to be executed by processing circuitry 403 of a first network node 102, whereby execution of the program code causes the first network node 102 to perform operations comprising:

receiving, 605, an authorization token request from a second network node;

determining, 607, whether or not a network function, NF consumer allows the second network node to represent the NF consumer; and

responsive to determining that the NF consumer allows the second network node to represent the NF consumer, transmitting, 611, an authorization token to the second network node.

24. The computer program according to Embodiment 23 whereby execution of the program code causes the first network node 102 to perform operations any of Embodiments 2-19.
25. A computer program product comprising a non-transitory storage medium including program code to be executed by processing circuitry 403 of a network function repository, first network node 102, whereby execution of the program code causes the first network node 102 to perform operations comprising:

receiving, 605, an authorization token request from a second network node;

determining, 607, whether or not a network function, NF consumer allows the second network node to represent the NF consumer; and

responsive to determining that the NF consumer allows the second network node to represent the NF consumer, transmitting, 611 an authorization token to the second network node.

26. The computer program product according to embodiment 25 whereby execution of the program code causes the first network node 102 to perform further operations the according to any of Embodiments 2-19.
27. A first network node 102 adapted to perform operations comprising:

receiving, 605, an authorization token request from a second network node;

determining, 607, whether or not a network function, NF consumer allows the second network node to represent the NF consumer; and

responsive to determining that the NF consumer allows the second network node to represent the NF consumer, transmitting, 611, an authorization token to the second network node.

28. The first network node 102 of Embodiment 27 wherein the first network node 102 implements a Network Repository Function, NRF and the second network node implements a service communication proxy, SCP.
29. The first network node 102 of any of Embodiments 27-28 wherein the authorization token request identifies an NF service producer and in determining whether or not the NF consumer allows the second network node to represent the NF consumer the first network node 102 is further adapted to perform operations comprising:

responsive, 703, to no consumer identifier being in the authorization token request:
determining, 705, which NF consumers are allowed to be represented by the second network node;
determining, 707, whether any of the NF consumers that are authorized to invoke services provided by the NF service producer are authorized to be represented by the second network node; and
responsive to any of the NF consumers that are authorized to invoke services provided by the NF service producer are authorized to be represented by the second network node, determining, 709, that the NF consumer allows the second network node to represent the NF consumer;

responsive, 703, to there being the consumer identifier in the authorization token:
determining, 711, whether the second network node is allowed to represent a NF consumer identified by the consumer identifier;
determining, 713, whether the NF consumer identified by the consumer identifier is authorized to invoke the services provided by the NF service producer; and
responsive to determining the second network node is allowed to represent a NF consumer identified by the consumer identifier and that the NF consumer identified by the consumer identifier is authorized to invoke the services provided by the NF service producer, determining, 715, that the NF consumer allows the second network node to represent the NF consumer.
   30. The first network node 102 of Embodiment 29, wherein the first network node 102 is further adapted to perform operations comprising:

determining 701 whether there is a consumer identifier in the authorization token request.

31. The first network node 102 of any of Embodiments 27-30, wherein the authorization token request identifies an NF service producer, wherein the first network node 102 is further adapted to perform operations comprising:

determining, 609. whether or not the NF service producer identified allows the second network node to represent NF consumers and

wherein responsive to determining that the NF consumer allows the second network node to represent the NF consumer, transmitting, 611, an authorization token to the second network node comprises responsive to determining that the NF consumer allows the second network node to represent the NF consumer and determining that the NF service producer identified allows the second network node to represent NF consumers, transmitting the authorization token to the second network node.

32. The first network node 102 of any of Embodiments 27-31, wherein the first network node 102 is further adapted to perform operations comprising:

receiving, 601, provision information indicating whether or not second network nodes are allowed to represent NF consumers; and

responsive to the provision information indicating that second network nodes are allowed to represent the NF consumers, determining, 603, which second network nodes are allowed to represent the NF consumers.

33. The first network node 102 of Embodiment 32, wherein the first network node 102 is further adapted to perform operations comprising:

Transmitting, 801, a provision information acknowledgement message to NF consumers identified in the provision information;

receiving, 803, a response to the provision information acknowledgement message;

responsive, 805, to the response indicating an approval to allow second network nodes, determining, 807, that the NF consumer allows the second network node to represent the NF consumer; and

responsive, 805, to the response indicating a denial to allow second network nodes, determining, 809, that the NF consumer does not allow the second network node to represent the NF consumer.

34. The first network node 102 of any of Embodiments 32-33, wherein the first network node 102 is further adapted to perform operations comprising:

transmitting, 901, a provision information acknowledgement message to NF service providers identified in the provision information;

receiving, 903, a response to the provision information acknowledgement message;

responsive, 905, to the response indicating an approval to allow second network nodes, determining, 907, that the NF service producer allows the second network node to represent the NF consumer; and

responsive, 905, to the response indicating a denial to allow second network nodes, determining, 909, that the NF service producer does not allow the second network node to represent the NF consumer.

35. The first network node 102 of any of Embodiments 32-34, wherein the first network node 102 is further adapted to perform operations comprising:

transmitting, 1001 a provision information acknowledgement message to a sender of the provision information.

36. The first network node 102 of Embodiment 35 wherein the first network node 102 is further adapted to perform operations comprising:

receiving, 1003, a response to the provision information acknowledgement message transmitted to the sender;

responsive, 1005, to the response indicating an approval to allow second network nodes, determining, 1007, that the second network node is allowed to represent the NF consumer; and

responsive, 1005, to the response indicating a denial to allow second network nodes, determining, 1009, that the second network node is not allowed to represent the NF consumer.

37. A first network node 102 adapted to perform operations comprising:

receiving, 605, an authorization token request from a second network node;

determining, 607, whether or not a Network Function, NF, consumer allows the second network node to represent the NF consumer;

determining, 609, whether or not an NF service producer identified in the authorization token allows the second network node to represent NF consumers; and

responsive to determining that the NF service producer identified in the authorization token allows the second network node to represent NF consumers and that the NF consumer allows the second network node to represent the NF consumer, transmitting, 611, an authorization token to the second network node.

38. The first network node 102 of Embodiment 37 wherein the first network node 102 implements a Network Repository Function, NRF and the second network node implements a service communication proxy, SCP.
39. The first network node 102 of any of Embodiments 37-38, wherein in determining whether or not the NF consumer allows the second network node to represent the NF consumer, the first network node 102 is adapted to perform further operations comprising:

responsive, 703 to no consumer identifier being in the authorization token request:
determining, 705, which NF consumers are allowed to be represented by the second network node;
determining, 707, whether any of the NF consumers that are authorized to invoke services provided by the NF service producer are authorized to be represented by the second network node; and
responsive to any of the NF consumers that are authorized to invoke services provided by the NF service producer are authorized to be represented by the second network node, determining, 709, that the NF consumer allows the second network node to represent the NF consumer;

responsive, 703, to there being the consumer identifier being in the authorization token:
determining, 711, whether the second network node is allowed to represent a NF consumer identified by the consumer identifier;
determining, 713, whether the NF consumer identified by the consumer identifier is authorized to invoke the services provided by the NF service producer; and
responsive to determining the second network node is allowed to represent a NF consumer identified by the consumer identifier and that the NF consumer identified by the consumer identifier is authorized to invoke the services provided by the NF service producer, determining, 715, that the NF consumer allows the second network node to represent the NF consumer.
   40. The first network node 102 of Embodiment 39, wherein the first network node 102 is adapted to perform further operations comprising:

determining, 701, whether there is a consumer identifier in the authorization token request.

41. The first network node 102 of any of Embodiments 37-40, wherein the first network node 102 is adapted to perform further operations comprising:
receiving, 601, provision information indicating whether or not second network nodes are allowed to represent NF consumers; and
responsive to the provision information indicating that second network nodes are allowed to represent the NF consumers, determining, 603, which second network nodes are allowed to represent the NF consumers.
   42. The first network node 102 of Embodiment 41, wherein the first network node 102 is adapted to perform further operations comprising:

transmitting, 801, a provision information acknowledgement message to NF consumers identified in the provision information;

receiving, 803, a response to the provision information acknowledgement message;

responsive, 805, to the response indicating an approval to allow second network nodes, determining, 807, that the NF consumer allows the second network node to represent the NF consumer; and

responsive, 805, to the response indicating a denial to allow second network nodes, determining, 809, that the NF consumer does not allow the second network node to represent the NF consumer.

43. The first network node 102 of any of Embodiments 41-42, wherein the first network node 102 is adapted to perform further operations comprising:

transmitting, 901, a provision information acknowledgement message to NF service providers identified in the provision information;

receiving, 903. a response to the provision information acknowledgement message;

responsive, 905, to the response indicating an approval to allow second network nodes, determining, 907, that the NF service producer allows the second network node to represent the NF consumer; and

responsive, 905, to the response indicating a denial to allow second network nodes, determining, 909, that the NF service producer does not allow the second network node to represent the NF consumer.

44. The first network node 102 of any of Embodiments 41-43, wherein the first network node 102 is adapted to perform further operations comprising:

transmitting, 1001, a provision information acknowledgement message to a sender of the provision information.

45. The first network node 102 of Embodiment 44, wherein the first network node 102 is adapted to perform further operations comprising

receiving, 1003, a response to the provision information acknowledgement message transmitted to the sender;

responsive, 1005, to the response indicating an approval to allow second network nodes, determining, 1007, that the second network node is allowed to represent the NF consumer; and

responsive, 1005, to the response indicating a denial to allow second network nodes, determining, 1009, that the second network node is not allowed to represent the NF consumer.

Explanations are provided below for various abbreviations/acronyms used in the present disclosure.

| Abbreviation | Explanation |
|---|---|
| 3GPP | 3rd Generation Partnership Project |
| NF | Network Function |
| NRF | Network Repository_ Function, also referred to as NF |
| | Repository Function or Network Resource Function |
| O&M | Operation and Maintenance |
| SCP | Service Communication Proxy |
| SeCoP | Service Communication Proxy |
| SECOP | Service Communication Proxy |

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 11 illustrates the wireless communication network in accordance with some embodiments.

Although the subject matter described herein may be implemented in any appropriate type of system using any suitable components, the embodiments disclosed herein are described in relation to a wireless communication network, such as the example wireless network illustrated in FIG. 11. For simplicity, the wireless communication network of FIG. 11 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless communication network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs, Access and Mobility Management Functions, AMFs, Session Management Functions, SMFs, Authentication Server Functions, AUSFs, Security Anchor Functions, SEAFs, Authentication credential Repository and Processing Function, ARPF, Unified Data Management, UDM, Subscription Identifier De-concealing Function, SIDF), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 11 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and an RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 11 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

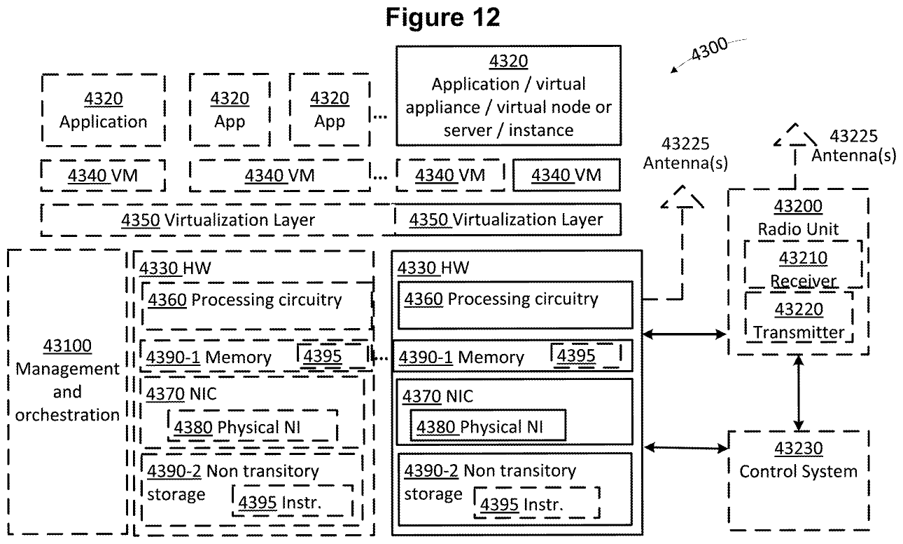

FIG. 12 illustrates a virtualization environment in accordance with some embodiments.

FIG. 12 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node or to a device or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340 comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 12, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 12.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “I”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, devices, computer programs and non-transitory storage medium and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows. Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a first network node (102) having a network repository function, the method comprising:
receiving (605) an authorization token request from a service communication proxy, SCP (104);
determining (607) whether or not a network function, NF, service consumer device (100) allows the SCP (104) to represent the NF service consumer device (100); and
responsive to determining that the NF service consumer device (100) allows the SCP (104) to represent the NF service consumer device (100), transmitting (611) an authorization token to the SCP (104).

2. The method of claim 1, wherein the SCP (104) is implemented in a core network node.

3. The method of any one of claims 1-2, wherein the authorization token request identifies an NF service producer device (106) and wherein determining whether or not the NF service consumer device (100) allows the SCP (104) to represent the NF service consumer device comprises:
responsive (703) to no consumer identifier being in the authorization token request:
determining (705) which NF service consumer devices are allowed to be represented by the SCP;
determining (707) whether any of the NF service consumer devices that are authorized to invoke services provided by the NF service producer device are authorized to be represented by the SCP; and
responsive to any of the NF service consumer devices that are authorized to invoke services provided by the NF service producer device are authorized to be represented by the SCP, determining (709) that the NF service consumer device allows the SCP to represent the NF service consumer device;
responsive (703) to there being the consumer identifier being in the authorization token request:
determining (711) whether the SCP is allowed to represent a NF service consumer device identified by the consumer identifier;
determining (713) whether the NF service consumer device identified by the consumer identifier is authorized to invoke the services provided by the NF service producer device; and
responsive to determining that the SCP is allowed to represent a NF service consumer device identified by the consumer identifier and that the NF service consumer device identified by the consumer identifier is authorized to invoke the services provided by the NF service producer device, determining (715) that the NF service consumer device allows the SCP to represent the NF service consumer device.

4. The method of claim 3, comprising:
determining (701) whether there is a consumer identifier in the authorization token request.

5. The method of any one of claims 1-4, wherein the authorization token request identifies an NF service producer device (106), the method comprising:
determining (609) whether or not the NF service producer device identified allows the SCP to represent NF service consumer devices; and
wherein responsive to determining that the NF service consumer device allows the SCP to represent the NF service consumer device, transmitting (611) an authorization token to the SCP comprises responsive to determining that the NF service consumer device allows the SCP to represent the NF service consumer device and determining that the NF service producer device identified allows the SCP to represent NF service consumer devices, transmitting the authorization token to the SCP.

6. The method of any one of claims 1-5, comprising:
receiving (601) provision information indicating whether or not SCPs are allowed to represent NF service consumer devices; and
responsive to the provision information indicating that SCPs are allowed to represent the NF service consumer devices.

7. The method of claim 6, comprising:
transmitting (801) a provision information acknowledgement message to NF service consumer devices identified in the provision information;
receiving (803) a response to the provision information acknowledgement message;
responsive (805) to the response indicating an approval to allow SCPs, determining (807) that the NF service consumer device allows the SCP to represent the NF service consumer device; and
responsive (805) to the response indicating a denial to allow SCPs, determining (809) that the NF service consumer device does not allow the SCP to represent the NF service consumer device.

8. The method of any one of claims 6-7, comprising:
transmitting (901) a provision information acknowledgement message to NF service providers identified in the provision information;
receiving (903) a response to the provision information acknowledgement message;
responsive (905) to the response indicating an approval to allow SCPs, determining (907) that the NF service producer device allows the SCP to represent the NF service consumer device; and
responsive (905) to the response indicating a denial to allow SCPs, determining (909) that the NF service producer device does not allow the SCP to represent the NF service consumer device.

9. The method of any one of claims 6-8, comprising:
transmitting (1001) a provision information acknowledgement message to a sender of the provision information.

10. The method of claim 9, further comprising:
receiving (1003) a response to the provision information acknowledgement message transmitted to the sender;
responsive (1005) to the response indicating an approval to allow SCPs, determining (1007) that the SCP is allowed to represent the NF service consumer device; and
responsive (1005) to the response indicating a denial to allow SCPs, determining (1009) that the SCP is not allowed to represent the NF service consumer device.

11. A method performed by a first network node (102) having a network repository function, the method comprising:
receiving (605) an authorization token request from a service communication proxy, SCP (104);
determining (607) whether or not a Network Function, NF, service consumer device (100) allows the SCP (104) to represent the NF service consumer device (100);
determining (609) whether or not an NF service producer device (106) identified in the authorization token allows the SCP (104) to represent NF service consumer devices; and
responsive to determining that the NF service producer device (106) identified in the authorization token allows the SCP (104) to represent NF service consumer devices and that the NF service consumer device (100) allows the SCP (104) to represent the NF service consumer device (100), transmitting (611) an authorization token to the SCP (104).

12. The method of claim 11, wherein determining whether or not the NF service consumer device (100) allows the SCP (104) to represent the NF service consumer device comprises:
responsive (703) to no consumer identifier being in the authorization token request:
determining (705) which NF service consumer devices are allowed to be represented by the SCP;
determining (707) whether any of the NF service consumer devices that are authorized to invoke services provided by the NF service producer device are authorized to be represented by the SCP; and
responsive to any of the NF service consumer devices that are authorized to invoke services provided by the NF service producer device are authorized to be represented by the SCP, determining (709) that the NF service consumer device allows the SCP to represent the NF service consumer device;
responsive (703) to there being the consumer identifier being in the authorization token request:
determining (711) whether the SCP is allowed to represent a NF service consumer device identified by the consumer identifier;
determining (713) whether the NF service consumer device identified by the consumer identifier is authorized to invoke the services provided by the NF service producer device; and
responsive to determining the SCP (104) is allowed to represent a NF service consumer device identified by the consumer identifier and that the NF service consumer device identified by the consumer identifier is authorized to invoke the services provided by the NF service producer device, determining (715) that the NF service consumer device allows the SCP to represent the NF service consumer device.

13. The method of claim 12, comprising:
determining (701) whether there is a consumer identifier in the authorization token request.

14. The method of any one of claims 12-13, further comprising:
receiving (601) provision information indicating whether or not SCPs are allowed to represent NF service consumer devices; and
responsive to the provision information indicating that SCPs are allowed to represent the NF service consumer devices, determining (603) which SCPs are allowed to represent the NF service consumer devices.

15. The method of claim 14, comprising:
transmitting (801) a provision information acknowledgement message to NF service consumer devices identified in the provision information;
receiving (803) a response to the provision information acknowledgement message;
responsive (805) to the response indicating an approval to allow SCPs, determining (807) that the NF service consumer device allows the SCP to represent the NF service consumer device; and
responsive (805) to the response indicating a denial to allow SCPs, determining (809) that the NF service consumer device does not allow the SCP to represent the NF service consumer device.

16. The method of any one of claims 14-15, comprising:
transmitting (901) a provision information acknowledgement message to NF service providers identified in the provision information;
receiving (903) a response to the provision information acknowledgement message;
responsive (905) to the response indicating an approval to allow SCPs, determining (907) that the NF service producer device allows the SCP to represent the NF service consumer device; and
responsive (905) to the response indicating a denial to allow SCPs, determining (909) that the NF service producer device does not allow the SCP to represent the NF service consumer device.

17. The method of any one of claims 14-16, comprising:
transmitting (1001) a provision information acknowledgement message to a sender of the provision information.

18. The method of claim 17, further comprising:
receiving (1003) a response to the provision information acknowledgement message transmitted to the sender;
responsive (1005) to the response indicating an approval to allow SCPs, determining (1007) that the SCP is allowed to represent the NF service consumer device; and
responsive (1005) to the response indicating a denial to allow SCPs, determining (1009) that the SCP is not allowed to represent the NF service consumer device.

19. A first network node (102) which comprises a network repository function, processing circuitry (403); and memory (405) coupled with the processing circuitry, wherein the memory includes instructions that when executed by the processing circuitry causes the first network node to perform operations comprising:
receiving (605) an authorization token request from a service communication proxy, SCP (104);
determining (607) whether or not a network function, NF service consumer device (100) allows the SCP (104) to represent the NF service consumer device (100); and
responsive to determining that the NF service consumer device (100) allows the SCP (104) to represent the NF service consumer device (100), transmitting (611) an authorization token to the SCP (104).

20. The first network node (102) according to claim 19 wherein the memory (405) includes instructions that when executed by the processing circuitry causes the first network node (102) to perform operations according to any one of claims 2-18.

21. A computer program (406) comprising program code to be executed by a processing circuitry (303) of a first network node (102) having a network repository function, whereby execution of the program code causes the first network node (102) to perform operations comprising:
receiving (605) an authorization token request from a service communication proxy, SCP (104);
determining (607) whether or not a network function, NF service consumer device (100) allows the SCP (104) to represent the NF service consumer device (100); and
responsive to determining that the NF service consumer device (100) allows the SCP (104) to represent the NF service consumer device (100), transmitting (611) an authorization token to the SCP (104).

22. A non-transitory storage medium (404) including program code to be executed by processing circuitry (403) of a first network node comprising a network function repository, whereby execution of the program code causes the first network node to perform operations comprising:
receiving (605) an authorization token request from a service communication proxy, SCP (104);
determining (607) whether or not a network function, NF service consumer device (100) allows the SCP (104) to represent the NF service consumer device (100); and
responsive to determining that the NF service consumer device (100) allows the SCP (104) to represent the NF service consumer device (100), transmitting (611) an authorization token to the SCP (104).

23. A first network node (102) having a network repository function adapted to perform operations comprising:
receiving (605) an authorization token request from a service communication proxy, SCP determining (607) whether or not a network function, NF service consumer device (100) allows the SCP (104) to represent the NF service consumer device (100); and
responsive to determining that the NF service consumer device (100) allows the SCP (104) to represent the NF service consumer device (100), transmitting (611) an authorization token to the SCP (104).

24. The first network node (102) of claim 23, wherein the authorization token request identifies an NF service producer device (106) and in determining whether or not the NF service consumer device (100) allows the SCP (104) to represent the NF service consumer device, the first network node (102) is adapted to perform operations comprising:
responsive (703) to no consumer identifier being in the authorization token request:
determining (705) which NF service consumer devices are allowed to be represented by the SCP;
determining (707) whether any of the NF service consumer devices that are authorized to invoke services provided by the NF service producer device are authorized to be represented by the SCP; and
responsive to any of the NF service consumer devices that are authorized to invoke services provided by the NF service producer device are authorized to be represented by the SCP, determining (709) that the NF service consumer device allows the SCP to represent the NF service consumer device; and
responsive (703) to there being the consumer identifier in the authorization token request:
determining (711) whether the SCP is allowed to represent a NF service consumer device identified by the consumer identifier;
determining (713) whether the NF service consumer device identified by the consumer identifier is authorized to invoke the services provided by the NF service producer device; and
responsive to determining the SCP (104) is allowed to represent a NF service consumer device identified by the consumer identifier and that the NF service consumer device identified by the consumer identifier is authorized to invoke the services provided by the NF service producer device, determining (715) that the NF service consumer device allows the SCP to represent the NF service consumer device (100).

25. The first network node (102) of claim 24, wherein the first network node (102) is adapted to perform operations comprising:
determining (701) whether there is a consumer identifier in the authorization token request.

26. The first network node (102) of any one of claims 23-25, wherein the authorization token request identifies an NF service producer device (106), wherein the first network node (102) is adapted to perform operations comprising:
determining (609) whether or not the NF service producer device identified allows the SCP to represent NF service consumer devices and
wherein responsive to determining that the NF service consumer device allows the SCP to represent the NF service consumer device, transmitting (611) an authorization token to the SCP comprises responsive to determining that the NF service consumer device allows the SCP to represent the NF service consumer device and determining that the NF service producer device identified allows the SCP to represent NF service consumer devices, transmitting the authorization token to the SCP (104).

27. The first network node (102) of any one of claims 23-26, wherein the first network node (102) is adapted to perform operations comprising:
receiving (601) provision information indicating whether or not SCPs are allowed to represent NF service consumer devices; and
responsive to the provision information indicating that SCPs are allowed to represent the NF service consumer devices, determining (603) which SCPs are allowed to represent the NF service consumer devices.

28. The first network node (102) of claim 27, wherein the first network node (102) is adapted to perform operations comprising:
transmitting (801) a provision information acknowledgement message to NF service consumer devices identified in the provision information;
receiving (803) a response to the provision information acknowledgement message;
responsive (805) to the response indicating an approval to allow SCPs, determining (807) that the NF service consumer device allows the SCP to represent the NF service consumer device; and
responsive (805) to the response indicating a denial to allow SCPs, determining (809) that the NF service consumer device does not allow the SCP to represent the NF service consumer device.

29. The first network node (102) of any one of claims 27-28, wherein the first network node (102) is adapted to perform operations comprising:
transmitting (901) a provision information acknowledgement message to NF service providers identified in the provision information;
receiving (903) a response to the provision information acknowledgement message;
responsive (905) to the response indicating an approval to allow SCPs, determining (907) that the NF service producer device allows the SCP to represent the NF service consumer device; and
responsive (905) to the response indicating a denial to allow SCPs, determining (909) that the NF service producer device does not allow the SCP to represent the NF service consumer device.

30. The first network node (102) of any one of claims 27-29, wherein the first network node (102) is adapted to perform operations comprising:
transmitting (1001) a provision information acknowledgement message to a sender of the provision information.

31. The first network node (102) of claim 30 wherein the first network node (102) is adapted to perform operations comprising:
receiving (1003) a response to the provision information acknowledgement message transmitted to the sender;
responsive (1005) to the response indicating an approval to allow SCPs, determining (1007) that the SCP (104) is allowed to represent the NF service consumer device (100); and
responsive (1005) to the response indicating a denial to allow SCPs, determining (1009) that the SCP is not allowed to represent the NF service consumer device (100).

32. A first network node (102) having a network repository function and is adapted to perform operations comprising:
receiving (605) an authorization token request from a service communication proxy, SCP (104);
determining (607) whether or not a Network Function, NF, service consumer device (100) allows the SCP (104) to represent the NF service consumer device (100);
determining (609) whether or not an NF service producer device (106) identified in the authorization token allows the SCP (104) to represent NF service consumer devices; and
responsive to determining that the NF service producer device (106) identified in the authorization token allows the SCP (104) to represent NF service consumer devices and that the NF service consumer device (100) allows the SCP (104) to represent the NF service consumer device (100), transmitting (611) an authorization token to the SCP (104).

33. The first network node (102) of claim 32, wherein in determining whether or not the NF service consumer device (100) allows the SCP (104) to represent the NF service consumer device, the first network node (102) is adapted to perform further operations comprising:
responsive (703) to no consumer identifier being in the authorization token request:
determining (705) which NF service consumer devices are allowed to be represented by the SCP;
determining (707) whether any of the NF service consumer devices that are authorized to invoke services provided by the NF service producer device are authorized to be represented by the SCP; and
responsive to any of the NF service consumer devices that are authorized to invoke services provided by the NF service producer device are authorized to be represented by the SCP, determining (709) that the NF service consumer device allows the SCP to represent the NF service consumer device;
responsive (703) to there being the consumer identifier being in the authorization token request:
determining (711) whether the SCP (104) is allowed to represent an NF service consumer device identified by the consumer identifier;
determining (713) whether the NF service consumer device identified by the consumer identifier is authorized to invoke the services provided by the NF service producer device; and
responsive to determining the SCP (104) is allowed to represent a NF service consumer device identified by the consumer identifier and that the NF service consumer device identified by the consumer identifier is authorized to invoke the services provided by the NF service producer device, determining (715) that the NF service consumer device allows the SCP to represent the NF service consumer device.

34. The first network node (102) of claim 33, wherein the first network node (102) is adapted to perform further operations comprising:
determining (701) whether there is a consumer identifier in the authorization token request.

35. The first network node (102) of any one of claims 32-34, wherein the first network node (102) is adapted to perform further operations comprising:
receiving (601) provision information indicating whether or not SCPs are allowed to represent NF service consumer devices; and
responsive to the provision information indicating that SCPs are allowed to represent the NF service consumer devices, determining (603) which SCPs are allowed to represent the NF service consumer devices.

36. The first network node (102) of claim 35, wherein the first network node (102) is adapted to perform further operations comprising:
transmitting (801) a provision information acknowledgement message to NF service consumer devices identified in the provision information;
receiving (803) a response to the provision information acknowledgement message;
responsive (805) to the response indicating an approval to allow SCPs, determining (807) that the NF service consumer device allows the SCP to represent the NF service consumer device; and
responsive (805) to the response indicating a denial to allow SCPs, determining (809) that the NF service consumer device does not allow the SCP to represent the NF service consumer device (100).

37. The first network node (102) of any one of claims 35-36, wherein the first network node (102) is adapted to perform further operations comprising:
transmitting (901) a provision information acknowledgement message to NF service providers identified in the provision information;
receiving (903) a response to the provision information acknowledgement message;
responsive (905) to the response indicating an approval to allow SCPs, determining (907) that the NF service producer device allows the SCP to represent the NF service consumer device; and
responsive (905) to the response indicating a denial to allow SCPs, determining (909) that the NF service producer device does not allow the SCP to represent the NF service consumer device (100).

38. The first network node (102) of any one of claims 35-37, wherein the first network node (102) is adapted to perform further operations comprising:
transmitting (1001) a provision information acknowledgement message to a sender of the provision information.

39. The first network node (102) of claim 38, wherein the first network node (102) is adapted to perform further operations comprising
receiving (1003) a response to the provision information acknowledgement message transmitted to the sender;
responsive (1005) to the response indicating an approval to allow SCPs, determining (1007) that the SCP is allowed to represent the NF service consumer device; and
responsive (1005) to the response indicating a denial to allow SCPs, determining (1009) that the SCP is not allowed to represent the NF service consumer device.
